(19) United States
(12) Patent Application Publication
(10) Pub. No.: US 2019/0012711 A1
(43) Pub. Date: Jan. 10, 2019

(54) ELECTRONIC SYSTEM AND METHOD FOR MERCHANT FEEDBACK ASSESSMENT

(71) Applicant: MASTERCARD INTERNATIONAL INCORPORATED, Purchase, NY (US)

(72) Inventor: Harleen Sachdeva, Patiala (IN)

(21) Appl. No.: 16/025,627

(22) Filed: Jul. 2, 2018

(30) Foreign Application Priority Data
Jul. 7, 2017 (SG) 10201705630Q

(51) Int. Cl. G06Q 30/02; G06Q 20/12

(52) U.S. Cl. CPC G06Q 30/0282; G06Q 20/4012; G06Q 20/12

(57) ABSTRACT

The present disclosure generally relates to an electronic system, a method, and a non-transitory computer-readable storage medium for assessing feedback provided by consumers in relation to a merchant. The system includes a host server communicatively linked to a payment network. The host server is configured for performing steps of the method, including receiving, from a merchant server operated by the merchant, transaction datasets for a number of transactions between the merchant and the consumers, each transaction dataset including identification data of the merchant, cost data of the transaction, details of a payment instrument of the consumer, and feedback data in relation to the merchant, communicating, for each transaction, the merchant identification data, transaction cost data, and consumer payment instrument details to the payment network for processing the transaction, communicating, for each transaction, the feedback data to a merchant feedback database, and generating a feedback assessment of the merchant.

### CROSS REFERENCE TO RELATED APPLICATIONS

This patent application claims priority to Singapore Patent Application No. 10201705630Q filed on Jul. 7, 2017, the disclosure of which is incorporated by reference herein in its entirety as part of the present application.

### BACKGROUND

The present disclosure generally relates to an electronic system and method for merchant feedback assessment. More particularly, the present disclosure describes various embodiments of an electronic system and method for assessing feedback provided by consumers/customers in relation to a merchant.

With numerous merchants available to consumers to select and purchase a wide range of products and services, it is increasingly important for a merchant to retain its existing consumers and increase its consumer base in order to keep the business viable. Good consumer experience is vital to increasing loyalty in businesses. One way for a merchant to know the consumer experience the merchant provides to consumers is requesting feedback from the consumers. Feedback provided by the consumers after a shopping experience or availing a service could offer insights on the quality of service provided by the merchant. The feedback could further be used by the merchant as a parameter to increase loyalty.

Some merchants request feedback from consumers by providing a questionnaire/survey for the consumers to fill in. The consumers then return the completed questionnaire, usually in paper form, to the merchant. This is a cumbersome process for the merchant as the merchant has to review all the paper questionnaires in order to glean useful information from the feedback provided. Some consumers are more conservative than others in providing feedback and will simply throw the questionnaire paper away. As such, the return rate of completed questionnaires is often very low. Moreover, even with the completed questionnaires, the merchant would only be able to know the consumers' feedback about the merchant. The merchant is unable to make comparisons with or benchmark themselves against other merchants.

Therefore, in order to address or alleviate at least one of the aforementioned problems and/or disadvantages, there is a need to provide an electronic system and method for merchant feedback assessment, in which there is at least one improved feature over the aforementioned prior art.

### BRIEF DESCRIPTION

A first aspect of the present disclosure provides an electronic system, a method, and a non-transitory computer-readable storage medium for assessing feedback provided by consumers in relation to a merchant. The system includes a host server communicatively linked to a payment network. The host server is configured for performing steps of the method, including receiving, via the payment network and from a merchant server operated by the merchant, transaction datasets for a number of transactions between the merchant and the consumers, each transaction dataset including identification data of the merchant, cost data of the transaction, details of a payment instrument of the consumer, and feedback data in relation to the merchant, the feedback data input by the consumer during the transaction, communicating, for each transaction, the merchant identification data, transaction cost data, and consumer payment instrument details to the payment network for processing the transaction, communicating, for each transaction, the feedback data to a merchant feedback database, and generating a feedback assessment of the merchant based on an aggregation of feedback data provided by the consumers in the merchant feedback database.

A second aspect of the present disclosure provides an electronic system, a method, and a non-transitory computer-readable storage medium for assessing feedback provided by consumers in relation to a merchant. The system includes a merchant server operated by the merchant. The merchant server is configured for performing steps of the method, including receiving details of a payment instrument of a consumer for payment of a transaction with the merchant, receiving feedback data in relation to the merchant, the feedback data input by the consumer during the transaction, generating a transaction dataset including identification data of the merchant, cost data of the transaction, the consumer payment instrument details, and the feedback data, and communicating the transaction dataset to a payment network for processing the transaction, wherein the feedback data is subsequently communicated from the payment network to a merchant feedback database for generating a feedback assessment of the merchant based on an aggregation of feedback data provided by the consumers in the merchant feedback database.

An advantage of the present disclosure is that due to the large number of transactions between merchants and consumers, multiple sets of feedback data provided by the consumers in relation to the various merchants can be collected. The feedback assessment generated from an aggregation of the feedback data can be used by a merchant to assess their business performance against other merchants. The feedback assessment of the merchant may vary depending on geography or locations and/or type of business/industry.

An electronic system and method for merchant feedback assessment are thus disclosed herein. Various features, aspects, and advantages of the present disclosure will become more apparent from the following detailed description of the embodiments of the present disclosure, by way of non-limiting examples only, along with the accompanying drawings.

### BRIEF DESCRIPTION OF THE DRAWINGS

FIG. 1 is an illustration of an electronic system for merchant feedback assessment, in accordance with embodiments of the present disclosure.

FIG. 2 is a flowchart illustration of a computerized method for merchant feedback assessment, in accordance with embodiments of the present disclosure.

FIG. 3 is a block diagram illustration of the technical architecture of a host server of the electronic system of FIG. 1, in accordance with embodiments of the present disclosure.

### DETAILED DESCRIPTION

In the present disclosure, depiction of a given element or consideration or use of a particular element number in a particular figure or a reference thereto in corresponding descriptive material can encompass the same, an equivalent, or an analogous element or element number identified in another figure or descriptive material associated therewith. The use of “/” in a figure or associated text is understood to mean “and/or” unless otherwise indicated. For purposes of brevity and clarity, descriptions of embodiments of the present disclosure are directed to an electronic system and method for merchant feedback assessment, in accordance with the drawings. While aspects of the present disclosure will be described in conjunction with the embodiments provided herein, it will be understood that they are not intended to limit the present disclosure to these embodiments. On the contrary, the present disclosure is intended to cover alternatives, modifications, and equivalents to the embodiments described herein, which are included within the scope of the present disclosure as defined by the appended claims. Furthermore, in the following detailed description, specific details are set forth in order to provide a thorough understanding of the present disclosure. However, it will be recognized by an individual having ordinary skill in the art, i.e., a skilled person, that the present disclosure may be practiced without specific details, and/or with multiple details arising from combinations of aspects of particular embodiments. In a number of instances, known systems, methods, procedures, and components have not been described in detail so as to not unnecessarily obscure aspects of the embodiments of the present disclosure.

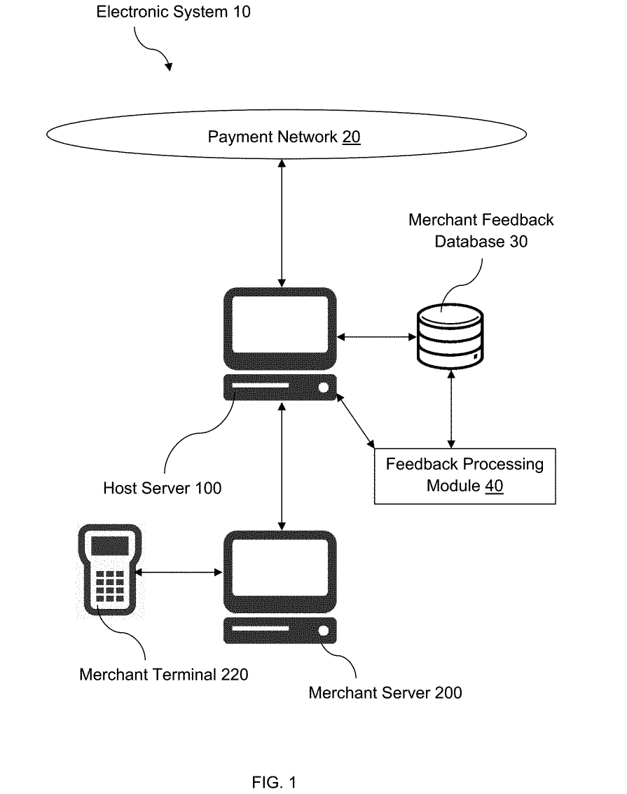

FIG. 1 is an illustration of an electronic system 10 for merchant feedback assessment, in accordance with embodiments of the present disclosure. The electronic system 10 includes a host server 100 having a processor and a data storage device or memory configured to store computer-readable instructions. The host server 100 is operative for assessing feedback provided by consumers/customers in relation to a merchant. The electronic system 10 further includes a payment network 20 for processing transactions between merchants and consumers. The payment network 20 may be operated by an organization such as a payment card or credit card association, such as MasterCard® or Visa®. The host server 100 is communicatively linked to the payment network 20, or it may alternatively be interpreted that the host server 100 is communicatively linked such that it forms part of, is integrally connected, or operative within the payment network 20.

The electronic system 10 further includes one or more merchant servers 200 communicatively linked to the host server 100. Each merchant server 200 is operated by a merchant for communicating transaction datasets associated with the transactions between the merchant and consumers to the payment network 20 for processing the transactions in a standard manner known to the skilled person.

In one embodiment, the merchant operates an internet portal for consumers to browse and make purchases online. The consumers check out and provide details of payment instruments together with feedback data in relation to the merchant via the internet portal, which are then communicated to the merchant server 200. The merchant server 200 receives the payment instrument details and generates the transaction datasets. The transaction datasets are subsequently communicated via the payment network 20 to the host server 100 where the feedback data is analyzed.

In another embodiment, the system 10 includes a merchant terminal 220 communicatively linked to the merchant server 200. The merchant terminal 220 may also be referred to as a merchant billing machine or point-of-sale (POS) terminal located at the premises of a retail store of the merchant. Payment instrument details of the consumer and feedback data in relation to the merchant are input/provided by the consumer to the merchant terminal 220. The merchant terminal 220 reads the payment instrument details upon insertion, swiping, or tapping of the payment instrument, e.g., credit card. The merchant terminal 220 includes a user input device, e.g., keypad, for the consumer to input the feedback data, as well as payment instrument authentication data such as personal identification number (PIN). The merchant terminal 220 may further be configured to accept digital wallets implemented on electronic or mobile devices of the consumers.

The term “payment instrument” may refer to any suitable cashless payment mode or mechanism, such as payment cards. Payment cards may include credit cards, debit cards, prepaid cards, and/or charge cards which the customer uses to pay for transactions. In addition to payment cards, payment instruments may include, but are not limited to, membership cards, promotional cards, frequent flyer cards, identification cards, gift cards, and/or any other payment cards that may hold payment card information and which may be stored electronically.

The electronic system 10 further includes a merchant feedback database 30 communicatively linked to the host server 100 for recording and maintaining feedback data provided by consumers in relation to various merchants. The merchant feedback database 30 may reside locally on the host server 100, or alternatively on a remote server or computer communicatively linked to the host server 100. The electronic system 10 further includes a feedback processing module 40 communicatively linked to or integrated with the host server 100 for retrieving and processing feedback data from the merchant feedback database 30.

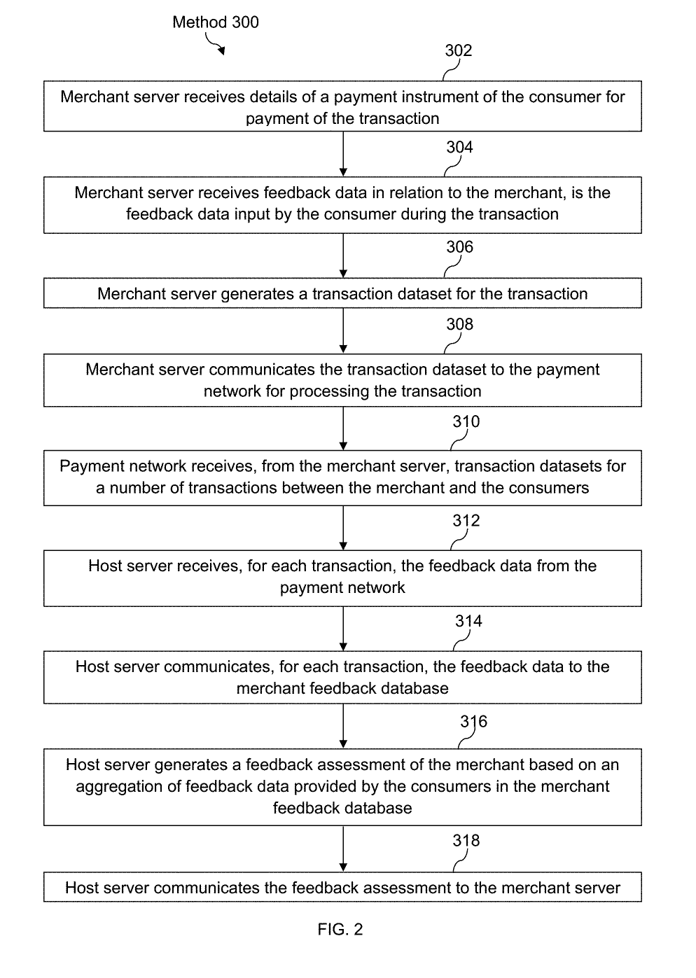

FIG. 2 is a flowchart illustration of a computerized method for merchant feedback assessment, in accordance with embodiments of the present disclosure. In various embodiments with reference to FIG. 2, there is shown a computer-implemented or computerized method 300, i.e., implemented on the electronic system 10, for assessing feedback provided by consumers in relation to a merchant. Particularly, the feedback in relation to the merchant is provided by the consumers during transactions with the merchant.

In a transaction between the merchant and a consumer, the method 300 includes a step 302 of the merchant server 200 receiving details of a payment instrument of the consumer for payment of the transaction. The payment instrument details may be communicated when the consumer inserts, swipes, or taps the payment instrument, e.g. credit card, at the merchant terminal 220. Alternatively, the payment instrument details are embedded in a digital wallet configured on a mobile device of the consumer. The consumer communicates the payment instrument details to the merchant terminal 220 via contactless/wireless communication protocols. Alternatively, the transaction is performed online using a computing device of the consumer and the payment instrument details are entered via the computing device.

In a step 304, the merchant server 200 receives feedback data in relation to the merchant, the feedback data input by the consumer during the transaction. In one embodiment, the transaction is performed at the retail premises of the merchant, and the consumer inputs the feedback data using the merchant terminal 220, such as with an input device or keypad thereof. In another embodiment, the transaction is performed online, and the consumer inputs the feedback data with the computing device.

The feedback data may be based on or includes a number of predefined rating scales, each rating scale corresponding to a particular question or statement. The consumer may be presented with a questionnaire/survey with a list of questions/statements, and the consumer is requested to provide his/her response inputs according to the predefined rating scales. One example of a rating scale is a Likert-type scale which provides a number of predefined responses for the consumer to select as a response to a question/statement. The questionnaire/survey may be drafted by the merchant and shared with the operator of the host server 100 which would receive the responses to the questions/statements in the questionnaire/survey. One example of a questionnaire/survey together with the predefined rating scales is shown in Table 1 below.

TABLE 1
Example Questionnaire/Survey

| Question/Statement | Rating Scale | | | | |
|---|---|---|---|---|---|
| 1. How would you rate | Very | Satisfied | Neutral | Dissatisfied | Very |
| your overall | satisfied | | | | dissatisfied |
| satisfaction with us | | | | | |
| (merchant)? | | | | | |
| 2. How likely are you | Very | Likely | Neutral | Unlikely | Very |
| to recommend us to | likely | | | | unlikely |
| others? | | | | | |

| | | | |
|---|---|---|---|
| 3. When was the last | Within the last 3 | Between 3 months | More than 6 |
| time you purchased a | months | and 6 months ago | months ago or |
| product or service from | | | never |
| us? | | | |

| | | | | |
|---|---|---|---|---|
| 4. Please rate our | Excellent | Good | Fair | Poor |
| customer service. | | | | |
| 5. Please rate our | Excellent | Good | Fair | Poor |
| products/services. | | | | |

Although the example questionnaire/survey in Table 1 above shows most of questions/statements being related to the merchant's business, additional questions/statements may be included in the questionnaire/survey to obtain personal details of the consumer, such as gender and age group. Collectively, the consumer details can provide information on the demographics of consumers patronizing the merchant and how the feedback data is related to the consumer demographics, such as how the feedback data can be segmented into various age groups.

With reference to the example in Table 1, the consumer inputs a number as a response to each question/statement. For example, an input of “1” for question/statement 1 corresponds to the response “very satisfied”; while an input of “2” for question/statement 2 corresponds to the response “likely”. Accordingly, the consumer may input a series of numbers, via the merchant terminal 220 for retail purchase or the computing device which the consumer is using for online purchase, in response to the set of questions/statements in the questionnaire/survey. For example, the consumer may input the series of numbers “12243” as the feedback data. The responses to the questionnaire/survey corresponding to the numbers “12243” is shown in Table 1 above, wherein the consumer responses are underlined.

In one embodiment, the payment instrument of the consumer requires an authentication data input, such as a signature, PIN, and/or biometric data. If the payment instrument requires a PIN as authentication, the consumer further inputs the PIN. In one embodiment, the PIN is input by the consumer on the merchant terminal 220. In another embodiment, the consumer is transacting online and the PIN is input on the computing device. The PIN may be a one-time password (OTP) communicated from an issuer bank of the payment instrument to a mobile device of the consumer.

The feedback data and the authentication data may be input successively by the consumer during the transaction. For example, the feedback data is a series of numbers “12243” and the PIN is a 6-digit number such as “123456”. The consumer may input a successive series of numbers “12345612243”. After the host server 100 receives this successive series of numbers, the host server 100 identifies the first 6 digits as the authentication data input and the remaining digits as the individual responses to the questions/statements in the questionnaire/survey. It will be appreciated that the successive series of numbers may be reversed, such that the feedback data is in front of the PIN.

The method 300 includes a step 306 of the merchant server 200 generating a transaction dataset for the transaction. The transaction dataset includes identification data of the merchant, cost data of the transaction, details of the payment instrument of the consumer, and the feedback data input by the consumer during the transaction. The transaction dataset may optionally include the authentication data if required by the payment instrument.

The transaction cost data refers to the cost or price of products/services being purchased by the consumer in the transaction. The merchant identification data includes the name of the merchant and may further include location details of the merchant retail premises if the consumer is making the transaction thereat. Notably, the merchant identification data enables the payment network 20 to identify a financial account of the merchant for receiving the transaction cost from the consumer payment instrument upon processing of the transaction.

In a step 308, the merchant server 200 communicates the transaction dataset to the payment network 20 for processing the transaction. The steps 302, 304, 306, and 308 described above relate to a transaction between a merchant and a consumer. It will be appreciated that the same steps are performed for other transactions between the merchant and other consumers, such that multiple transaction datasets are generated by the merchant server 200 and communicated to the payment network 20.

In a step 310, the payment network 20 receives, from the merchant server 200, transaction datasets for a number of transactions between the merchant and the consumers. Each transaction dataset is generated by the merchant server 200 and includes the merchant identification data, transaction cost data, consumer payment instrument details, and feedback data input by the consumer during the transaction. Each transaction dataset is embedded in a standard financial transaction message according to known international standards, such as ISO 8583 and ISO 20022, as will be readily understood by the skilled person. For example, the feedback data in the transaction dataset is captured as part of one or more fields/data elements of the standard financial transaction message.

The payment network 20 facilitates communication of each transaction dataset between an acquirer financial institution/bank of the merchant and an issuer financial institution/bank of the consumer. It will be appreciated that the transaction is processed by the acquirer and issuer banks in a standard manner known to the skilled person.

In a step 312, the host server 100 receives, for each transaction, the feedback data from the payment network 20. More specifically, the host server 100 receives at least a portion of the transaction dataset (including at least the feedback data) via the payment network 20 and from the merchant server 200. The feedback data is extracted from the transaction dataset by the host server 100 and for subsequent processing and analysis.

In a step 314, the host server 100 communicates, for each transaction, the feedback data to the merchant feedback database 30. The feedback data may be anonymized before communication to the merchant feedback database 30, so that consumers are assured that they cannot be identified from their feedback data. Consumers will feel more comfortable to provide feedback on merchants. This anonymization may include dissociating or delinking the feedback data from the payment instrument details in the transaction dataset. To preserve the anonymity, the merchant server 200 does not store a copy of the feedback data on their transaction records.

The steps 310, 312, and 314 described above relate to multiple transactions between a merchant and the consumers. It will be appreciated that the same steps are performed for multiple transactions between other merchants and consumers, such that multiple sets of feedback data are received by the host server 100 and stored on the merchant feedback database 30.

In a step 316, the host server 100 generates a feedback assessment of the merchant based on an aggregation of feedback data provided by the consumers in the merchant feedback database 30. More specifically, the feedback processing module 40 retrieves feedback data from the merchant feedback database 30, aggregates and processes the feedback data to generate the feedback assessment of the merchant. In a step 318, the host server 100 communicates the feedback assessment to the merchant server 200, so that the merchant is obtain useful information based on the feedback assessment and to make appropriate adjustments to its business.

In one embodiment, the merchant has multiple retail stores distributed across multiple locations. When a transaction is performed with the merchant, the merchant identification data in the transaction dataset includes location data which enables the host server 100 to identify the specific merchant location. Accordingly, the feedback data provided by consumers in relation to the merchant can be sorted by the merchant locations. The feedback assessment includes computing a number of first aggregated scores of the merchant. Each first aggregated score is associated with a location of the merchant identified by the merchant identification data.

Each first aggregated score is calculated based on the feedback data provided by consumers who transacted at the associated merchant location. Specifically, feedback data relevant to the merchant at the associated merchant location is retrieved from the merchant feedback database 30 and aggregated together to compute the first aggregated score for this location. Various algorithms may be implemented to compute the first aggregated scores based on the responses on the predefined rating scales. For example, various weights may be applied on various questions/statements in the questionnaire/survey, depending on the significance thereof. For a more standardized measure of comparison, the computed first aggregated scores may be scaled between 0 and 5 or between 0% and 100%.

The feedback assessment may further include comparing the first aggregated score associated with a location of the merchant against the first aggregated scores associated with other locations of the merchant. A ranking of the merchant locations based on the first aggregated scores may be provided in the feedback assessment. Based on the feedback assessment, the merchant can gauge or assess the performance of one merchant location to other merchant locations.

For each of one or more merchant locations, the feedback assessment may include first aggregated scores of other merchants at the same location(s). The feedback assessment may further include comparing the first aggregated score associated with a location of the merchant against other merchants at the location. This allows the merchant to benchmark the performance of the retail store at the merchant location against other retail stores of other merchants at the same location.

In another embodiment, the host server 100 is able to determine a merchant category code (MCC) based on the merchant identification data. The MCC classifies the merchant business by the type of goods or services the merchant provides. The feedback assessment may include comparing the first aggregated score associated with a location of the merchant against other merchants of an identical MCC and at the same location. This allows the merchant to benchmark the performance of one of its retail stores against the retail stores of other merchants at the same location and in a similar business as they share a common MCC.

Multiple first aggregated scores of a merchant are computed if the merchant has multiple retail stores at various locations. The feedback assessment may include computing a second aggregated score of the merchant aggregated from the first aggregated scores of the merchant. Various algorithms may be implemented to compute the second aggregated scores based on the first aggregated scores. For example, the second aggregated score is an average or mean of all the first aggregated scores. Furthermore, various weights may be applied on various first aggregated scores, depending on the significance thereof. A higher weight may be applied on the first aggregated score associated with a merchant location where the merchant has a flagship retail store.

The feedback assessment may include comparing the second aggregated score of the merchant against other merchants of an identical MCC determined from the merchant identification data. This allows the merchant to benchmark its performance against other merchants in a similar business as they share a common MCC. A benchmark score or index may be computed for all merchants with the same MCC. The second aggregated score of the merchant can be compared against this benchmark score/index so the merchant determine whether its second aggregated score is above, same, or below it, thereby determining whether its performance is above, same, or below the average.

The payment network 20 processes a large number of transactions between various merchants and the consumers. As such, the host server 100 is able to collect multiple sets of feedback data provided by the consumers in relation to the various merchants. The feedback data is optionally and voluntarily provided by the consumers, and usually at the time of producing the payment instrument details for making payment of a transaction. By requesting feedback from the consumers at this stage of the transaction, the feedback data offers firsthand information and vital clues on the quality of service provided by the merchant and could be used as a parameter to increase loyalty.

The feedback assessment of a merchant allows the merchant to internally assess and benchmark its business performance at one merchant location or branch against other merchant locations or branches. The feedback assessment can also be used for external assessment of the merchant's performance against other merchants at the same location or in a similar geography. External assessment or comparison may also be done broadly, i.e. across all branches of the merchant, against merchants with the same or related MCC. The feedback assessment of the merchant can thus vary depending on geography or locations and/or type of business/industry. The feedback assessment may also vary based on consumer demographics, e.g. age group.

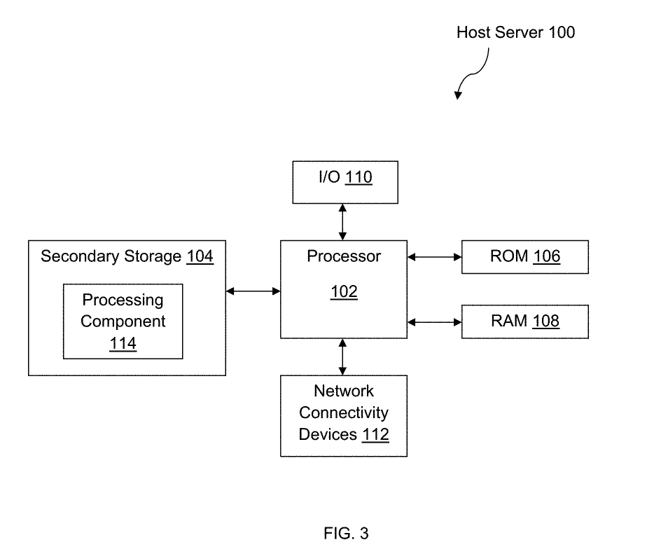

The following is a description of the technical architecture of the host server 100 with reference to FIG. 3. It will be appreciated that the merchant server 200 may have a similar technical architecture as that of the host server 100.

The technical architecture of the host server 100 includes a processor 102 (also referred to as a central processor unit or CPU) that is in communication with memory devices including secondary storage 104 (such as disk drives or memory cards), read only memory (ROM) 106, and random access memory (RAM) 108. The processor 102 may be implemented as one or more CPU chips. Various modules or components for performing various operations or steps of the method 300 are configured as part of the processor 102 and such operations or steps are performed in response to non-transitory instructions operative or executed by the processor 102.

The technical architecture further includes input/output (I/O) devices 110, and network connectivity devices 112. The secondary storage 104 typically includes a memory card or other storage device and is used for non-volatile storage of data and as an over-flow data storage device if RAM 108 is not large enough to hold all working data. Secondary storage 104 may be used to store programs which are loaded into RAM 108 when such programs are selected for execution.

The secondary storage 104 has a processing component 114, including non-transitory instructions operative by the processor 102 to perform various operations or steps of the method 300 according to various embodiments of the present disclosure. The ROM 106 is used to store instructions and perhaps data which are read during program execution. The secondary storage 104, the ROM 106, and/or the RAM 108 may be referred to in some contexts as computer-readable storage media and/or non-transitory computer-readable media. Non-transitory computer-readable media include all computer-readable media, with the sole exception being a transitory propagating signal per se.

The I/O devices 110 may include printers, video monitors, liquid crystal displays (LCDs), plasma displays, touch screen displays, keyboards, keypads, switches, dials, mice, track balls, voice recognizers, card readers, paper tape readers, and/or other known input devices.

The network connectivity devices 112 may take the form of modems, modem banks, Ethernet cards, universal serial bus (USB) interface cards, serial interfaces, token ring cards, fibre distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other known network devices. These network connectivity devices 112 may enable the processor 102 to communicate with the Internet or one or more intranets. With such a network connection, it is contemplated that the processor 102 might receive information from the network, or might output information to the network in the course of performing the operations or steps of the method 300. Such information, which is often represented as a sequence of instructions to be executed using processor 102, may be received from and outputted to the network, for example, in the form of a computer data signal embodied in a carrier wave.

The processor 102 executes instructions, codes, computer programs, scripts which it accesses from hard disk, floppy disk, optical disk (these various disk based systems may all be considered secondary storage 104), flash drive, ROM 106, RAM 108, or the network connectivity devices 112. While only one processor 102 is shown, multiple processors may be present. Thus, while instructions may be discussed as executed by a processor, the instructions may be executed simultaneously, serially, or otherwise executed by one or multiple processors.

It will be appreciated that the technical architecture of the host server 100 may be formed by one computer, or multiple computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the multiple computers. In an embodiment, virtualization software may be employed by the technical architecture to provide the functionality of a number of servers that is not directly bound to the number of computers in the technical architecture. In an embodiment, the functionality disclosed above may be provided by executing the application and/or applications in a cloud computing environment. Cloud computing may include providing computing services via a network connection using dynamically scalable computing resources. A cloud computing environment may be established by an enterprise and/or may be hired on an as-needed basis from a third party provider.

It is understood that by programming and/or loading executable instructions onto the technical architecture of the host server 100, at least one of the CPU 102, the ROM 106, and the RAM 108 are changed, transforming the technical architecture in part into a specific purpose machine or apparatus having the functionality as taught by various embodiments of the present disclosure. It is fundamental to the electrical engineering and software engineering arts that functionality that can be implemented by loading executable software into a computer can be converted to a hardware implementation by known design rules.

In the foregoing detailed description, embodiments of the present disclosure in relation to an electronic system and method for merchant feedback assessment are described with reference to the provided figures. The description of the various embodiments herein is not intended to call out or be limited only to specific or particular representations of the present disclosure, but merely to illustrate non-limiting examples of the present disclosure. The present disclosure serves to address at least one of the mentioned problems and issues associated with the prior art. Although only some embodiments of the present disclosure are disclosed herein, it will be apparent to a person having ordinary skill in the art in view of this disclosure that a variety of changes and/or modifications can be made to the disclosed embodiments without departing from the scope of the present disclosure. Therefore, the scope of the disclosure as well as the scope of the following claims is not limited to embodiments described herein.

1. An electronic system for assessing feedback provided by consumers in relation to a merchant, the system comprising a host server communicatively linked to a payment network, the host server configured for performing steps comprising:
receiving, via the payment network and from a merchant server operated by the merchant, transaction datasets for a number of transactions between the merchant and the consumers, each transaction dataset comprising identification data of the merchant, cost data of the transaction, details of a payment instrument of the consumer, and feedback data in relation to the merchant, the feedback data input by the consumer during the transaction;
communicating, for each transaction, the merchant identification data, transaction cost data, and consumer payment instrument details to the payment network for processing the transaction;
communicating, for each transaction, the feedback data to a merchant feedback database; and
generating a feedback assessment of the merchant based on an aggregation of feedback data provided by the consumers in the merchant feedback database.

2. The system according to claim 1, wherein the feedback data input by the consumer is based on a number of predefined rating scales.

3. The system according to claim 1, wherein the feedback assessment comprises computing a number of first aggregated scores of the merchant, each first aggregated score associated with a location of the merchant identified by the merchant identification data.

4. The system according to claim 3, wherein the feedback assessment further comprises comparing a first aggregated score associated with a location of the merchant against other locations of the merchant.

5. The system according to claim 3, wherein the feedback assessment further comprises comparing a first aggregated score associated with a location of the merchant against other merchants at the location.

6. The system according to claim 5, wherein the feedback assessment further comprises comparing the first aggregated score of the merchant against other merchants of an identical merchant category code determined from the merchant identification data.

7. The system according to claim 3, wherein the feedback assessment further comprises computing a second aggregated score of the merchant aggregated from the first aggregated scores of the merchant.

8. The system according to claim 7, wherein the feedback assessment further comprises comparing the second aggregated score of the merchant against other merchants of an identical merchant category code determined from the merchant identification data.

9. A non-transitory computer-readable storage medium storing computer-readable instructions that, when executed, cause a host server to perform a method for assessing feedback on a merchant provided by consumers in relation to a merchant, the method comprising:
receiving, via a payment network and from a merchant server operated by the merchant, transaction datasets for a number of transactions between the merchant and the consumers, each transaction dataset comprising identification data of the merchant, cost data of the transaction, details of a payment instrument of the consumer, and feedback data in relation to the merchant, the feedback data input by the consumer during the transaction;
communicating, for each transaction, the merchant identification data, transaction cost data, and consumer payment instrument details to the payment network for processing the transaction;
communicating, for each transaction, the feedback data to a merchant feedback database; and
generating a feedback assessment of the merchant based on an aggregation of feedback data provided by the consumers in the merchant feedback database.

10. The non-transitory computer-readable storage medium according to claim 9, the method further comprising communicating the feedback assessment to the merchant server.

11. An electronic system for assessing feedback provided by consumers in relation to a merchant, the system comprising a merchant server operated by the merchant, the merchant server configured for performing steps comprising:
receiving details of a payment instrument of a consumer for payment of a transaction with the merchant;
receiving feedback data in relation to the merchant, the feedback data input by the consumer during the transaction;
generating a transaction dataset comprising identification data of the merchant, cost data of the transaction, the consumer payment instrument details, and the feedback data; and
communicating the transaction dataset to a payment network for processing the transaction, wherein the feedback data is subsequently communicated from the payment network to a merchant feedback database for generating a feedback assessment of the merchant based on an aggregation of feedback data provided by the consumers in the merchant feedback database.

12. The system according to claim 11, further comprising a merchant terminal communicatively linked to the merchant server, wherein the feedback data in relation to the merchant is input by the consumer via the merchant terminal.

13. The system according to claim 11, wherein the feedback data input by the consumer is based on a number of predefined rating scales.

14. The system according to claim 11, the steps further comprising receiving authentication data input by the consumer, wherein the transaction dataset further comprises the authentication data.

15. The system according to claim 14, wherein the feedback data and the authentication data are input successively by the consumer.

16. (canceled)

17. (canceled)

18. (canceled)
